(19) United States
(12) Patent Application Publication
(10) Pub. No.: US 2004/0160855 A1
(43) Pub. Date: Aug. 19, 2004

(54) Static mixer and a process for producing dispersions in particular dispersions of liquid fuel with water

(76) Inventors: Guido Rivolta, Vigevano (IT); Alberto De Amicis, Milano (IT); Eugenio Barbiano di Belgiojoso, Milano (IT); Carlo Andrea Bertoglio, Rovescala (IT)

Correspondence Address: Finnegan Henderson Farabow, Garrett & Dunner, 1300 I Street NW, Washington, DC, 20005, US

(21) Appl. No.: 10/478,648

(22) PCT Filed: May 17, 2002
(86) PCT No.: PCT/EP02/05482

(30) Foreign Application Priority Data
May 30, 2001 (EP) 01830352.9

(51) Int. Cl. B01F 5/06

(52) U.S. Cl. 366/176.2

(57) ABSTRACT

A static mixer (1)to emulsify water and/or other additives in gas oil comprises a hollow structure (2) within which two mixing units (23,27) are disposed, each comprising a first and a second mixing bodies (24, 25, 28, 29) each carrying a frusto-conical boundary surface (24a, 25a, 28a, 29a). The boundary surfaces (24a, 25a, 28a, 29a) are disposed mutually opposite in parallel and facing each other so as to define a narrow mixing gap (26, 30) of truncated conical form at which the mixture runs in a condition of substantially laminar flow and is submitted to shear forces causing emulsification. Also proposed is a process for producing a dispersion, which process can be carried out by said mixer (1).

The present invention relates to a static mixer and to a process for producing dispersions of at least two substantially immiscible fluids, in particular dispersions of a liquid fuel with water, in which said static mixer is employed.

Within the present description and the claims, by the term “dispersion” it is intended a heterogenous system comprising at least one continuous phase consisting of a first fluid (in the following referred to as “primary fluid”) and at least one dispersed phase consisting of a second fluid (in the following referred to as “secondary fluid”) which is substantially immiscible in the first fluid, said dispersed phase being in the form of particles (droplets) of average sizes generally lower than 5 μm, preferably lower than 1 μm. This system can be possibly stabilized by addition of at least one emulsifying agent(or surfactant). In the last-mentioned case, the dispersion may also be called, in a more appropriate manner, “emulsion”, or also “microemulsion”. Also falling within the above definition are dispersions consisting of several primary fluids and/or several secondary fluids, i.e. dispersions in which the dispersed phase and/or the continuous phase consist of mixtures of various products.

Within the present description and the claims, by the term “static mixer” it is generally intended a device that does not contain moving parts and is adapted to cause dispersion of fluids that are substantially immiscible with each other.

In such a device the mechanical dispersion action is obtained through intense shear forces exerted on a feed flow of the primary and secondary fluids by stationary mixing elements which deviate the feed flow and/or force the latter to pass through preferential channels.

It is known that the liquid hydrocarbon combustion, for supply to internal combustion engines or for heat production for example, bring to formation of many polluting agents, in particular soot, particulate, carbon monoxide (CO), nitrogen oxides (NOx), sulphur oxides (SOx), non-combusted hydrocarbons which greatly contribute to pollution. It is also known that addition of controlled amounts of water to the fuel can reduce production of some polluting agents to an important extent. This effect is believed to be the result of different phenomena triggered by the presence of water in the combustion region. For instance, water, by lowering the combustion peak temperature reduces emission of nitrogen oxides (NOx) formation of which is promoted by high temperatures. In addition, an instantaneous water vaporization promotes a better fuel dispersion in the combustion chamber, thereby greatly reducing formation of soot, particulate and CO. These phenomena take place without jeopardizing efficiency of the combustion process.

A fuel emulsified with water is described in the patent application EP-A-630 398 and it is obtained by mixing of the components in a static mixer under particular pressure and temperature conditions in the presence of a surface-active mixture consisting of sorbitane-oleate, a polyalkylene glycol and an ethoxylated alkylphenol.

Another process for producing emulsions, in particular emulsions of liquid fuels and water, and the related apparatus are disclosed in the Patent Application EP-A-958 853, in which the fluids to be emulsified are injected into an emulsifying chamber provided with an injection system of such a nature that a motion in a direction substantially orthogonal to the overall passing-through direction of the emulsifying chamber by the fluids themselves is imparted.

Also known in the art are different types of mixers of the static type, in particular adapted for dispersion of low-viscosity fluids. A mixer of this type is described in U.S. Pat. No. 5,575,561, for example. In more detail, in such a document a mixer is disclosed which is arranged for dispersion of different fluids by means of at least one narrowing passage arranged in a hollow structure defining an advance path of the mixture of the fluids to be dispersed.

The narrowing passage is defined by a pair of solid bodies of which the first consists of a conveying ring directly engaged in the inner surface of the hollow structure, whereas the second consists of a shearing head concentric with the conveying ring and the hollow structure. The conveying ring has a cylindrical portion from which a cone-shaped portion extends which terminates with a perimetric sharp-corner edge close to the shearing head. The latter is partly centrally inserted in the conveying ring by a first cone-shaped portion. Extending from the first cone-shaped portion is an intermediate cylindrical portion which is connected to a second cone-shaped portion oriented in the opposite direction relative to the first cone-shaped portion.

The shearing head is separated a short distance from the perimetric sharp-corner edge of the conveying ring so that a passage clearance of narrow section is defined between the same.

In addition, associated with the shearing head is a frusto-conical collar extending in the extension of the surface of the first cone-shaped portion. The frusto-conical collar circumscribes the intermediate portion of the shearing head and has a central opening of a greater diameter than the diameter of the intermediate portion. This dimensional difference between the frusto-conical collar and the shearing head defines an auxiliary passage channel extending close to the shearing head from a region close to the perimetral edge of the conveying ring to the second conical portion of the shearing head itself. The fluid mixture being fed passes through the conveying ring and is directed by the cone-shaped portion of the latter and the first cone-shaped portion of the shearing head towards the passage clearance and the auxiliary passage channel. Therefore part of the fluid passes through the narrow section of the passage clearance at which it is submitted to shear forces with generation of a motion of the turbulent type.

The dispersion thus produced goes on within the mixer between the frusto-conical collar and the hollow structure until past the collar itself.

The Applicant has become aware of the possibility of obtaining dispersions of fluids that are substantially immiscible with each other, in particular dispersions of a liquid fuel with water, by forcing a mixture of the fluids to be dispersed to go along one or more gaps each defined by parallel and opposite boundary surfaces facing each other at a close distance. In this way the fluid mixture is submitted to intense shear forces substantially in a condition of laminar flow causing dispersion of the secondary liquid in the primary liquid in very fine particles with a high efficiency in energy transfer, essentially due to the molecular cohesion forces and the momentum exchanges between adjacent fluid layers running at different velocities.

In more detail, in a first aspect the present invention relates to a static mixer comprising at least one hollow structure having at least one inlet opening to be hydraulically connected with a fluid feeding duct and at least one outlet opening to be hydraulically connected with a fluid delivery duct; at least one mixing unit disposed within said hollow structure; characterized in that said at least one mixing unit comprises a first mixing body and a second mixing body having at least a first boundary surface and at least a second boundary surface respectively, which are opposite to each other and substantially parallel and positioned to a predetermined distance so as to define at least one mixing gap through which said fluid runs and is submitted to shear forces.

In a further aspect the present invention relates to a process for producing a dispersion of at least one primary fluid with at least one secondary fluid, said fluids being substantially immiscible with each other, comprising the step of causing passage of a mixture of said primary fluid with said secondary fluid along at least one mixing gap defined by at least a first boundary surface and at least a second boundary surface, which are opposed to each other and substantially parallel, and are positioned to a predetermined distance so as to submit said mixture to shear forces.

Further features and advantage will become more apparent from the detailed description of a preferred but not exclusive embodiment of a static mixer and a process for producing dispersions, in particular dispersions of a liquid fuel with water, in accordance with the present invention. This description will be set forth hereinafter with reference to the accompanying drawings given by way of non-limiting example, in which:

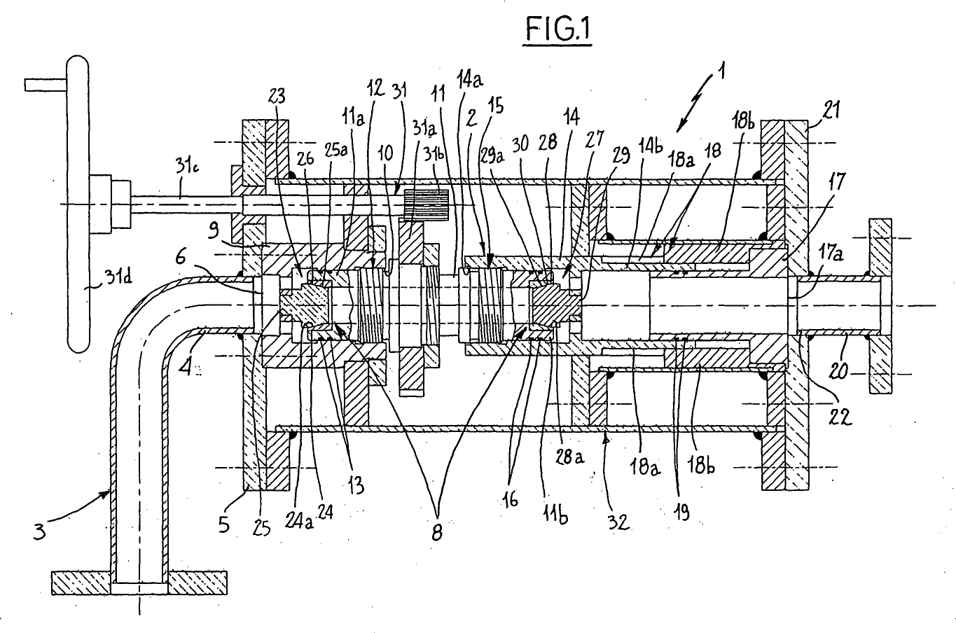

FIG. 1 is a section of a static mixer in accordance with the present invention;

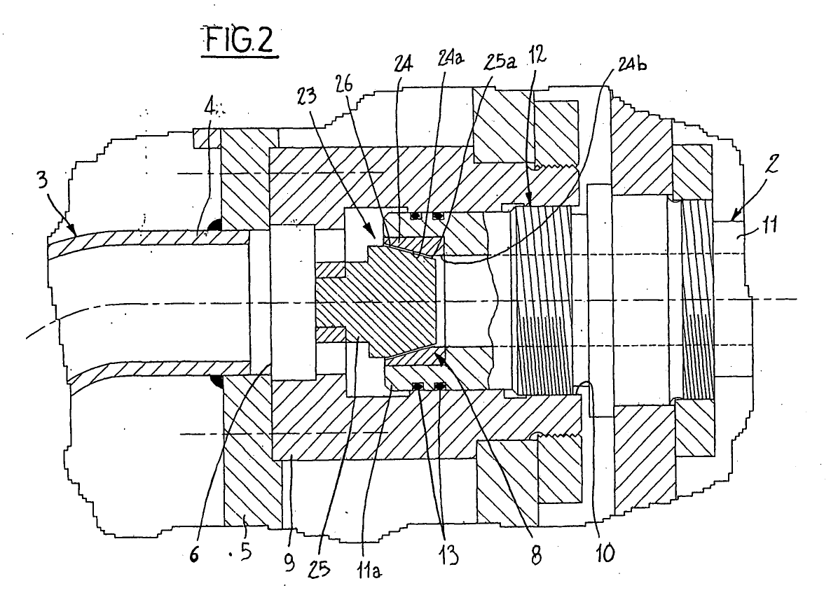

FIG. 2 is a detail of the static mixer in FIG. 1, to an enlarged scale.

With reference to the drawings, a static mixer in accordance with the present invention has been generally identified by reference numeral 1.

The static mixer 1 comprises at least one hollow structure 2 to be hydraulically connected with a duct 3 for feeding a mixture of the fluids to be dispersed, for example a mixture comprising a liquid-hydrocarbon (in particular a diesel fuel) and water, and possibly other additives as hereinafter specified.

As shown in FIG. 1, the feeding duct 3 terminates at an end 4 thereof, with a first attachment flange 5. The feeding duct 3 is arranged to convey the mixture to an inlet opening 6 formed in the hollow structure 2 and is rigidly connected with the latter by threaded elements or other connecting members not shown.

The hollow structure 2 is internally provided with at least one mixing region 8 at which at least one mixture passage section of an appropriate width is defined, said width being smaller than the width of any other passage section that can be found within the hollow structure itself, so that the mixture being fed is submitted to a dispersion action in which the dispersed phase is distributed in the continuous phase.

The first attachment flange 5 is rigidly in engagement with a fixed portion 9 of the hollow structure 2 in which the inlet opening 6 of the hollow structure is formed. Preferably, the fixed portion 9 is made in a tubular conformation so that it linearly prolongs the mixture way from the feeding duct 3. On the opposite side with respect to the inlet opening 6, the fixed portion 9 has a connecting opening 10 designed to be engaged with a first end 11a of a movable portion 11 of the hollow structure 2 preferably having a substantially tubular conformation. In detail, the first end 11a of the movable portion 11 is fitted in the connecting opening 10 of the fixed portion 9 and is in engagement therewith by first sliding-coupling devices 12.

The first sliding-coupling devices 12 are defined by a first and a second screw threads susceptible of being mutually engaged and formed internally of the fixed portion 9 and externally of the first end 11a of the movable portion 11, respectively. More specifically, the first sliding-coupling devices 12 ensure a movable engagement between the fixed portion 9 and the movable portion 11 in such a manner that the latter can carry out an axial translation, with respect to the fixed portion 9, along a substantially rectilinear direction, following a relative rotation between said portions. Also provided in association with the first sliding-coupling devices 12 is one or more ring seals 13 housed in respective seats externally formed on the first end 11a of the movable portion 11 and arranged to internally act against the fixed portion 9 to avoid leakages of the mixture being fed.

On the opposite side from the first end 11a, the movable portion 11 is operatively in engagement by its second end 11b, with an auxiliary movable portion 14 of the hollow structure 2, preferably having a substantially tubular conformation. In more detail, the second end 11b is fitted in a connecting opening 14a of the auxiliary movable portion 14 and internally engaged therewith by second sliding-coupling devices operatively interposed between the movable portion 11 and the auxiliary movable portion 14.

The second sliding-coupling devices 15 are defined by a first and a second screw threads, to be engaged with each other in a screwing direction opposed to the screwing direction of the threads of the first sliding-coupling devices 12. The first thread of the second sliding coupling devices 15 is formed within the auxiliary movable portion 14 whereas the second thread is formed on the outer surface of the second end 11b of the movable portion 11.

In order to avoid possible leakages of the mixture, further ring seals 16 associated with the second sliding-coupling devices 15 are also provided. These ring seals are placed in respective seats externally formed in the second end 11b of the movable portion 11 and arranged to internally act against the auxiliary movable portion 14.

As viewed from FIG. 1, the auxiliary movable portion 14 is operatively engaged, on the opposite side from the movable portion 11, with an auxiliary fixed portion 17 of the hollow structure 2 of substantially tubular conformation as well. In more detail, the auxiliary movable portion 14 is mechanically connected to the auxiliary fixed portion 17 by third sliding-coupling devices 18 operatively interposed between the fixed portion and the auxiliary movable portion 14.

The third sliding-coupling devices 18 are defined by one or more coupling seats 18a longitudinally formed in an engagement end 14b of the auxiliary movable portion 14 opposite to the connecting opening 14a, and by respective coupling elements 18b associated with the auxiliary fixed portion 17.

As shown in FIG. 1, the engagement end 14b of the auxiliary movable portion 14 is fitted on the auxiliary fixed portion 17 and the coupling elements 18b of the third sliding-coupling devices 18 are fitted in the respective coupling seats 18b carried by the same engagement end 14b.

The third sliding-coupling devices 18 ensure a relative movable engagement between the auxiliary movable portion 14 and the auxiliary fixed portion 17, only enabling axial translations of the auxiliary movable portion 14 on the auxiliary fixed portion 17.

The third sliding-coupling devices 18 too are provided with ring seals 19 put in respective seats externally formed in the fixed portion 17 and arranged to internally act against the auxiliary movable portion 14, to avoid leakages of the mixture.

On the opposite side from the auxiliary movable portion 14, the auxiliary fixed portion 17 has an outlet opening 17a through which the mixture comes out of the hollow structure 2 to enter a delivery connection nozzle 20 adapted to be connected to the diesel production and/or storage plant. In detail, the auxiliary fixed portion 17 is arranged against a second attachment flange 21 carried by an end 22 of the delivery connection nozzle 20 and is rigidly engaged therewith by screw threaded elements or other connecting members not shown.

The fixed portion 9, movable portion 11 and auxiliary movable portion 14 define the above mentioned mixing region 8 where formation of the dispersion occurs. In more detail, at least one mixing unit 23 is disposed within the hollow structure 2 and at the mixing region 8; said unit has a first and a second mixing body 24, 25 fitted into each other and having respective boundary surfaces 24a, 25a, preferably of frusto-conical conformation, disposed in a mutually opposite position and facing each other in parallel at a predetermined distance from each other to define at least one mixing gap 26 through which the mixture is caused to pass.

The distance existing between the boundary surfaces 24a, 25a determines the width of the passage section of the mixture that, in the mixing gap 26, does not exceed the width of the passage section that can be found in any other part of mixer 1.

The length of the mixing gap 26 corresponds to the length of the generatrix of each boundary surface 24a, 25a. The ratio between the length of the mixing gap 26 and the distance between the boundary surfaces 24a, 25a is generally at least as high as 10, and preferably has a value of 25 to 100.

In order to achieve a satisfactory dispersion of the feed mixture, it is preferable that the distance between the boundary surfaces 24a, 25a should be smaller than 2 mm and, more preferably, of a value included between 0.2 and 0.5 mm.

More particularly, the first mixing body 24 substantially is of a ring-shaped conformation and has at least one central opening 24b coaxial therewith and inside which the boundary surface 24a is defined.

Still with reference to the accompanying drawings, the second mixing body 25 is made up of a frusto-conical ogive disposed in coaxial relationship with the first mixing body 24 and carrying the respective boundary surface 25a.

Preferably, at least one of said first and second mixing bodies 24, 25 is movable to enable the distance between the boundary surfaces 24a, 25a to be varied. In more detail, as shown in the accompanying figures, to this end it is provided that the first mixing body 24 should be associated with the movable portion 11, and the second mixing body 25 should be associated with the fixed portion 9. Consequently, the axial movement of the movable portion 11 relative to the fixed portion 9 gives rise to a relative movement between the mixing bodies 24, 25 between a first position in which the respective boundary surfaces 24a, 25a are disposed in mutual contact or at all events to a minimum preestablished distance and a second position in which the latter are disposed to a maximum preestablished distance. However it should be noted that, for the purpose of forming the dispersion, the positions of the mixing bodies 24, 25 can also be reversed by associating the second mixing body 25 with the movable portion 11 and the first mixing body 24 with the fixed portion 9.

The static mixer 1 may further comprise an auxiliary mixing unit 27 disposed internally of the hollow structure 2 at the mixing region 8 of the latter.

As shown in the accompanying figures, the auxiliary mixing unit 27 is almost identical to the above described mixing unit 23. In fact, the auxiliary mixing unit 27 comprises a first auxiliary mixing body 28 and a second auxiliary mixing body 29 fitted in the first body. The auxiliary mixing bodies 28, 29 have respective auxiliary boundary surfaces 28a, 29a, preferably of frusto-conical conformation as well, mutually opposite and facing each other in parallel at a predetermined distance to define at least one auxiliary mixing gap 30 through which the mixture is caused to pass.

Preferably, at least one of said first and second auxiliary mixing bodies 24, 25 is movable to enable variation of the distance between the auxiliary bounding surfaces 28a, 29a. More specifically, as shown in the accompanying figures, the first auxiliary mixing body 28 is associated with the movable portion 11 and the second auxiliary mixing body 29 is associated with the auxiliary movable portion 14. There is an interaction between the screw threads of the second sliding-coupling devices 15 in order to cause, following the rotations imparted to the movable portion 11, relative axial displacements between the movable portion itself and the auxiliary movable portion 14. Consequently, the auxiliary mixing bodies 28, 29 are submitted to relative displacements between a first position in which the respective auxiliary boundary surfaces 28a, 29a are disposed in contact with each other or to a minimum preestablished distance and a second position in which the latter are disposed to a maximum preestablished distance.

As better shown in FIG. 2, the boundary surfaces 24a, 25a preferably converge in the opposite direction, i.e. on moving away relative to the inlet opening 6 towards a common longitudinal axis “X” of the movable portion 11. In other words, the boundary surfaces 24a, 25a converge in the feed direction of the mixture flow. This advantageously gives rise to an increasing reduction in the passage section of the mixture moving on along the mixing gap 26, with a consequent progressive increase in the velocity of same on moving away from the inlet opening 6.

In the embodiment shown, the auxiliary boundary surfaces 28a, 29a of the auxiliary mixing gap 30 in turn converge towards the longitudinal axis “X” in the opposite direction relative to the outlet opening 17a.

Advantageously, this configuration makes it possible to reverse the mixture feed direction without however affecting the quality of the obtained dispersion. It should be noted however, that it is also possible to dispose the auxiliary mixing bodies 28, 29 in such a manner that the auxiliary boundary surfaces 28a, 29a should have the same inclination as the boundary surfaces 24a, 25a, i.e. converging towards axis “X” in the feed direction of the mixture being fed. Under this situation the first auxiliary mixing body 28 could be associated with the auxiliary movable portion 14 whereas the second auxiliary mixing body 29 could be associated with the movable portion 11.

The static mixer 1 can further be provided with control means 31 operatively associated with the hollow structure 2 to move the portions 9, 11, 14, 17 of the latter relative to each other thereby moving, as a result, the boundary surfaces 24a, 25a, and the auxiliary boundary surfaces 28a, 29a between the first and second positions. In more detail, the control means 31 comprises at least one cogwheel 31a fitted on the movable portion 11 of the hollow structure 2. The cogwheel 31a operatively meshes with a pinion gear 31b carried by a shaft 31c extending in parallel to axis “X”. On the opposite side from the cogwheel 31a, a drive crank 31d is rigidly engaged with an end of shaft 31c.

The static mixer 1 further comprises a housing 32 fully circumscribing the hollow structure 2 of the static mixer 1 and partly circumscribing the control means 31 of the latter.

Operation of the static mixer 1 detailed above mainly as regards structure is as follows.

The mixture fed at high pressures generally included between 5 and 60 bars, preferably between 10 and 40 bars, passes through the feeding duct 3 until it reaches the fixed portion 9 of the hollow structure 2 of the static mixer 1, at which it encounters the mixing unit 23.

In the mixing gap 26 the mixture, due to the reduced section of the gap itself, undergoes a strong increase in its velocity while keeping a condition of substantially laminar flow and is submitted to shear forces causing dispersion of the secondary fluid in the primary fluid in the form of droplets having an average diameter generally lower than 5 μm preferably lower than 1 μm. In more detail, within the narrow mixing gap 26, the mixing layers that are closer to the boundary surfaces 24a, 25a have a lower advance velocity than the advance velocity of the other layers. Consequently the mixture within the mixing gap 26 is submitted to relative flows giving rise to shear forces between adjacent layers mainly caused by the molecular cohesion forces and by momentum exchanges due to passage (by diffusion) of molecules between layers at different velocities. These shear forces cause dispersion of the secondary liquid within the primary liquid.

The dispersion thus achieved goes along the movable portion reaching the auxiliary mixing unit 27 at which it is again submitted to the above described dispersing effect.

Subsequently, the mixture reaches the delivery duct 20 through which it leaves the hollow structure 2.

By acting on the control means 31 the distance between the boundary surfaces 24a, 25a and the auxiliary surfaces 28a, 29a can be adjusted, which will consequently enable adjustment of the intensity of the dispersing action exerted by the shear forces to adapt it to the requirements and/or physico-chemical features of the dispersing phase and the dispersed phase.

In more detail, by imparting a rotation to the drive crank 31d, rotation of the movable portion 11 is caused through the shaft 31c, the pinion gear 31b carried by the latter and the cogwheel 31a. The movable portion 11 rotates depending on the rotation direction given to the drive crank 31d, thereby moving axially away from or close to the fixed portion 9. As a result, the first mixing body 24 and second mixing body 25 move away from or close to each other and the distance between the boundary surfaces 24a, 25a of the latter increases or decreases, thereby making the passage section of the mixture in the mixing gap 26 larger or smaller.

Simultaneously, interaction between the screw threads of the second sliding-coupling devices causes a relative axial displacement between the movable portion 11 and the auxiliary movable portion 14 which move away from or close to each other depending on the rotation direction of the movable portion itself.

Consequently, also the first auxiliary mixing body 28 and the second auxiliary mixing body 29 move away from or close to each other, thereby making the passage section of the mixture in the auxiliary mixing gap 30 larger or smaller.

Under this situation; the auxiliary movable portion 14 axially slides on the auxiliary fixed portion 17 by means of third sliding-coupling devices 18 thereby moving close to or away from said auxiliary fixed portion.

The present invention solves the problems found in the known art and reaches the intended purposes.

First of all the static mixer 1 being the object of the present invention enables an excellent dispersion of the phases to be achieved with a high efficiency and without the help of sharp corners present along the advance path of the same. In fact, said dispersion is obtained by means of pairs of frusto-conical surfaces 24a, 25a, 28a, 29a disposed to a close distance from each other, which define narrow passage channels 26, 30 for the fluid passing therethrough.

It is also to be noted that the dispersion obtained by such a static mixer 1 has a fine and homogeneous distribution of the dispersed phase in the continuous phase. This is made possible by the substantially laminar flow of the mixture layers along the passage channels 26, 30.

It should be also recognized that the static mixer 1 in accordance with the present invention also enables management of the dispersion degree between the phases, depending on requirements. In more detail, by directly intervening on the drive crank 31c of the control means 31 it is possible to simultaneously vary the distance existing between the boundary surfaces 24a, 25a and the auxiliary boundary surfaces 28a, 29a.

As previously stated, the apparatus of the present invention can be advantageously employed for production of dispersions, possibly stabilized by at least one emulsifying agent, of liquid fuels and water, to be used for combustion processes in general, in particular for internal-combustion engines, in particular Diesel engines, thermal plants for heat or steam production, incinerators, turbine generators, etc.

In particular, the dispersion produced in accordance with the above description can be directly fed to a device for combustion of same, or sent to a storage tank to be fed to the combustion device later.

While in the present invention particular reference is made to dispersions in which the water is dispersed in a liquid fuel, the static mixer according to the present invention can be employed for production of dispersions of other types, consisting for example of a non water-soluble product dispersed in an aqueous phase, or in any case dispersions intended for uses in sectors other than combustion, for instance in the food or pharmaceutical sectors, or for preparation either of pigments for paints and varnishes, or of fireproof or fire-preventing products, and the like.

With reference to dispersions of a liquid fuel with water, the liquid fuel is the main component of the primary fluid, whereas the secondary fluid mainly consists of water.

As the liquid fuel, use can be made of a liquid hydrocarbon or a mixture of liquid hydrocarbons generally deriving from distillation of petroleum and essentially consisting of mixtures of aliphatic, naphthenic, olefinic and/or aromatic hydrocarbons, and generally having a viscosity at 50° C. from 1 to 500 cSt and a density at 15° C. from 0.75 to 1.1 kg/dm³. The liquid fuel can be for example selected from: gas oils (diesel oils) for means of transport (diesel fuel) or heat production, kerosenes, fuel oils, fuels for aircraft use (Jet Fuels).

The aqueous phase may consist either of water just as it is from waterworks or recycle or of demineralized or deionized water or even of waste water from a technological process.

The amount of the water dispersed in the liquid fuel is previously established so as to obtain the desired reduction in the pollutants without impairing the heat yield of the combustion process. This amount is generally included between 3 and 40% by weight, preferably between 7 and 20% by weight, with respect to the overall weight of the dispersion.

Several different additives can be added to the dispersions of liquid fuel and water, the nature and amount of which depend on the specific application for which the dispersion is designed. These additives can be selected for example from: surfactants, antifreezing agents, lubricants, cetane improvers, corrosion-inhibiting agents, biocides, antifoaming agents, sulphur sorbents, etc. These additives are generally carried, depending on their solubility features, through the aqueous phase or the hydrocarbon phase.

In particular, in order to increase stability of the produced dispersions, surfactants or mixtures of surfactants known in the art can be employed.

1. A static mixer comprising:
at least one hollow structure (2) having at least one inlet opening (6) adapted to be hydraulically connected to a fluid feeding duct (3) and at least one outlet opening (17a) adapted to be hydraulically connected to a fluid delivery duct (20);
at least one mixing unit (23) disposed internally of said hollow structure (2);
characterized in that said at least one mixing unit (23) comprises a first mixing body (24) and a second mixing body (25) having at least a first boundary surface (24a) and at least a second boundary surface (25a) respectively, which are opposite to each other and substantially parallel, and positioned to a predetermined distance from each other so as to define at least one mixing gap (26) through which said fluid flows and is submitted to shear forces.

2. A static mixer as claimed in claim 1, wherein the mixing gap (26) is substantially devoid of sharp corners so that the fluid is given a condition of substantially laminar flow.

3. A static mixer as claimed in anyone of the preceding claims, wherein at least one of the first and second mixing bodies (24, 25) is movable to enable the distance between the boundary surfaces (24a, 25a) to be modified.

4. A static mixer as claimed in anyone of the preceding claims, wherein said mixing gap (26) has a length corresponding to the length of the generatrix of each boundary surface (24a, 25a) and is of such a nature that the ratio between the length of said mixing gap (26) and the distance between the boundary surfaces (24a, 25a) is at least as high as 10.

5. A static mixer as claimed in claim 4, wherein the ratio between the length of said mixing gap (26) and the distance between the boundary surfaces (24a, 25a) has a value included between 15 and 50.

6. A static mixer as claimed in anyone of the preceding claims, wherein the distance between said boundary surfaces (24a, 25a) is lower than 2 mm.

7. A static mixer as claimed in claim 6, wherein the distance between said boundary surfaces (24a, 25a) is included between 0.2 and 0.5 mm.

8. A static mixer as claimed in anyone of the preceding claims, wherein the boundary surfaces (24a, 25a) of the mixing gap (26) are substantially frusto-conical.

9. A static mixer as claimed in claim 8, wherein said boundary surfaces (24a, 25a) have a common axis (“X”) and converge in the opposite direction relative to the inlet opening (6).

10. A static mixer as claimed in anyone of the preceding claims; further comprising at least one auxiliary mixing unit (27) disposed internally of said hollow structure (2) and having a first auxiliary mixing body (28) and a second auxiliary mixing body (29) fitted in said first auxiliary mixing body (28), said first and second auxiliary mixing bodies (28, 29) having at least a first auxiliary boundary surface (28a) and at least a second auxiliary boundary surface (29a) respectively, which are opposite to each other and substantially parallel, and positioned to a predetermined distance from each other so as to define at least one auxiliary mixing gap (30) through which said fluid flows and is submitted to shear forces.

11. A static mixer as claimed in claim 10, wherein at least one of said first and second auxiliary mixing bodies (28, 29) is movable to enable the distance between the auxiliary boundary surfaces (28a, 29a) to be modified.

12. A static mixer as claimed in claim 10 or 11, wherein the auxiliary boundary surfaces (28a, 29a) of the auxiliary mixing gap (30) are substantially frusto-conical.

13. A static mixer as claimed in claim 12, wherein said auxiliary boundary surfaces (28a, 29a) have a common axis (“X”) and converge in the opposite direction relative to the outlet opening (17a).

14. A static mixer as claimed in anyone of the preceding claims, wherein said hollow structure (2) comprises:
at least one substantially tubular fixed portion (9);
at least one substantially tubular movable portion (11);
first sliding-coupling devices (12) operatively interposed between said fixed (9) and movable (11) portions to give rise to a movable engagement of said portions between a first position in which the boundary surfaces (24a, 25a) are disposed to a minimum preestablished distance and a second position in which the boundary surfaces (24a, 25a) are disposed to a maximum preestablished distance.

15. A static mixer as claimed in claim 14, wherein said first mixing body (24) is associated with said fixed portion (11) and said second mixing body (25) is associated with said movable portion (9).

16. A static mixer as claimed in claim 14 or 15, wherein said first sliding-coupling devices (12) comprise:
a first screw thread formed on said fixed portion (9);
a second screw thread formed on said movable portion (11), said first and second threads being mutually engaged by screwing.

17. A static mixer as claimed in anyone of claims 10 to 16, wherein said hollow structure (2) further comprises:
at least one substantially tubular auxiliary fixed portion (17);
at least one substantially tubular auxiliary movable portion (14);
second sliding-coupling devices (15) operatively interposed between said auxiliary movable portion (14) and said movable portion (11);
third sliding-coupling devices (18) operatively interposed between said auxiliary movable portion (14) and said auxiliary fixed portion (17), said first, second and third sliding-coupling devices (12, 15, 18) mutually interacting in such a manner that when said fixed and movable portions (9, 11) are in the first position, said auxiliary boundary surfaces (28a, 29a) of said auxiliary mixing bodies (28, 29) are disposed to a minimum preestablished distance and, vice versa, when the fixed and movable portions (9, 11) are in the second position, the auxiliary boundary surfaces (28a, 29a) are disposed to a maximum preestablished distance.

18. A static mixer as claimed in claim 17, wherein said first auxiliary mixing body (28) is associated with said movable portion (11) and said second auxiliary mixing body (29) is associated with said auxiliary movable portion (14).

19. A static mixer as claimed in anyone of claims 10 to 18, further comprising:
at least one cogwheel (31a) fitted on said movable portion (11);
at least one shaft (31c) operatively associated with said cogwheel (31a) by at least one pinion gear (31b) associated with the shaft;
at least one drive crank (31d) rigidly in engagement with an end of said gear shaft (31c).

20. A process for producing a dispersion of at least one primary fluid with at least one secondary fluid, said fluids being substantially immiscible with each other, comprising the step of causing passage of a mixture of said primary fluid and secondary fluid along at least one mixing gap (26) defined by at least a first boundary surface (24a) and at least a second boundary surface (25a) which are opposite to each other and substantially parallel, and positioned to a predetermined distance from each other so as to submit said mixture to shear forces.

21. A process as claimed in claim 20, wherein said mixture is caused to pass along the mixing gap in a condition of substantially laminar flow.

22. A process as claimed in claim 20, carried out by a static mixer as claimed in anyone of claims 1 to 19.

23. A process as claimed in claim 20, wherein the primary fluid comprises a liquid fuel and the secondary fluid comprises water.

24. A process as claimed in claim 23, wherein the liquid fuel comprises at least one liquid hydrocarbon of a viscosity at 40° C. from 1 to 53 cSt and a density at 15° C. from 0.75 to 1.1 kg/dm³.

25. A process for production and combustion of a dispersion between a liquid fuel and water, comprising:
producing the dispersion between the liquid fuel and water;
feeding said dispersion to a device for combustion of the dispersion;
carrying out combustion of the dispersion; wherein the dispersion is produced according to anyone of claims from 20 to 24.

26. A process as claimed in claim 25, wherein the dispersion thus produced is directly fed to the device for combustion of the dispersion.

27. A process as claimed in claim 25, wherein the dispersion thus produced is first sent to a storage tank and then fed to the device for combustion of the dispersion.

28. A process as claimed in anyone of claims from 20 to 27, wherein the device for combustion of the dispersion is an internal-combustion engine.

29. A process as claimed in anyone of claims from 20 to 27, wherein the device for combustion of the dispersion is a burner.
